(19) United States
(12) Patent Application Publication
(10) Pub. No.: US 2023/0061530 A1
(43) Pub. Date: Mar. 2, 2023

(54) PULSE WIDTH EXTENSION DEVICE, LASER DEVICE, AND ELECTRONIC DEVICE MANUFACTURING METHOD

(71) Applicant: Gigaphoton Inc., Tochigi (JP)

(72) Inventors: Hitoshi OHGA, Oyama-shi (JP); Shinichi MATSUMOTO, Oyama-shi (JP); Hirotaka MIYAMOTO, Oyama-shi (JP)

(73) Assignee: Gigaphoton Inc., Tochigi (JP)

(21) Appl. No.: 18/053,732

(22) Filed: Nov. 8, 2022

Related U.S. Application Data
(63) Continuation of application No. PCT/JP2020/023003, filed on Jun. 11, 2020.

(51) Int. Cl. H01S 3/00

(52) U.S. Cl. CPC H01S 3/0057

(57) ABSTRACT

A pulse width extension device includes a first delay optical system having a first loop optical path formed on a first plane and configured by a first beam splitter and a plurality of first concave mirrors, a second delay optical system having a second loop optical path formed on a second plane parallel to and different from the first plane and configured by a second beam splitter and a plurality of second concave mirrors, and a first beam rotation mechanism arranged on an optical path between the first delay optical system and the second delay optical system and configured to rotate a beam of pulse laser light having passed through the first delay optical system so that a longitudinal direction of a beam cross-sectional shape of the pulse laser light traveling on the second loop optical path is perpendicular to the second plane.

The present application claims the benefit of International Application No. PCT/JP2020/023003, filed on Jun. 11, 2020 the entire contents of which are hereby incorporated by reference.

### BACKGROUND

### 1. Technical Field

The present disclosure relates to a pulse width extension device, a laser device, and an electronic device manufacturing method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248 nm and an ArF excimer laser device for outputting laser light having a wavelength of about 193 nm are used.

The KrF excimer laser device and the ArF excimer laser device each have a large spectral line width of about 350 to 400 μm in natural oscillation light. Therefore, when a projection lens is formed of a material that transmits ultraviolet rays such as KrF laser light and ArF laser light, there is a case in which chromatic aberration occurs. As a result, the resolution may decrease. Then, a spectral line width of laser light output from the gas laser device needs to be narrowed to the extent that the chromatic aberration can be ignored. For this purpose, there is a case in which a line narrowing module (LNM) including a line narrowing element (etalon, grating, and the like) is provided in a laser resonator of the gas laser device to narrow a spectral line width. In the following, a gas laser device with a narrowed spectral line width is referred to as a line narrowing gas laser device.

### LIST OF DOCUMENTS

### Patent Documents

Patent Document 1: Japanese Patent Application Publication No. 2011-176358
Patent Document 2: U.S. Pat. No. 7,184,204

### SUMMARY

A pulse width extension device according to an aspect of the present disclosure includes a first delay optical system including a first beam splitter and a plurality of first concave mirrors, and having a first loop optical path formed on a first plane, the first loop optical path being configured by the first beam splitter and the plurality of first concave mirrors; a second delay optical system including a second beam splitter and a plurality of second concave mirrors, and having a second loop optical path formed on a second plane parallel to and different from the first plane, the second loop optical path being configured by the second beam splitter and the plurality of second concave mirrors; and a first beam rotation mechanism arranged on an optical path between the first delay optical system and the second delay optical system and configured to rotate a beam of pulse laser light having passed through the first delay optical system so that a longitudinal direction of a beam cross-sectional shape of the pulse laser light traveling on the second loop optical path is perpendicular to the second plane.

A laser device according to another aspect of the present disclosure includes a laser oscillator configured to output pulse laser light, and a pulse width extension device arranged on an optical path of the pulse laser light. Here, the pulse width extension device includes a first delay optical system including a first beam splitter and a plurality of first concave mirrors, and having a first loop optical path formed on a first plane, the first loop optical path being configured by the first beam splitter and the plurality of first concave mirrors; a second delay optical system including a second beam splitter and a plurality of second concave mirrors, and having a second loop optical path formed on a second plane parallel to and different from the first plane, the second loop optical path being configured by the second beam splitter and the plurality of second concave mirrors; and a first beam rotation mechanism arranged on an optical path between the first delay optical system and the second delay optical system and configured to rotate a beam of the pulse laser light having passed through the first delay optical system so that a longitudinal direction of a beam cross-sectional shape of the pulse laser light traveling on the second loop optical path is perpendicular to the second plane.

An electronic device manufacturing method according to another aspect of the present disclosure includes generating laser light with a pulse width extended using a laser device, outputting the laser light to an exposure apparatus, and exposing a photosensitive substrate to the laser light in the exposure apparatus to manufacture an electronic device. Here, the laser device includes a first delay optical system including a first beam splitter and a plurality of first concave mirrors, and having a first loop optical path formed on a first plane, the first loop optical path being configured by the first beam splitter and the plurality of first concave mirrors; a second delay optical system including a second beam splitter and a plurality of second concave mirrors, and having a second loop optical path formed on a second plane parallel to and different from the first plane, the second loop optical path being configured by the second beam splitter and the plurality of second concave mirrors; and a first beam rotation mechanism arranged on an optical path between the first delay optical system and the second delay optical system and configured to rotate a beam of the pulse laser light having passed through the first delay optical system so that a longitudinal direction of a beam cross-sectional shape of the pulse laser light traveling on the second loop optical path is perpendicular to the second plane.

### BRIEF DESCRIPTION OF THE DRAWINGS

Embodiments of the present disclosure will be described below merely as examples with reference to the accompanying drawings.

FIG. 1 schematically shows a configuration example of a laser device according to a comparative example.

FIG. 2 is a top view schematically showing the configuration of the laser device according to a first embodiment.

FIG. 3 is a front view schematically showing the configuration of the laser device according to the first embodiment.

FIG. 4 is a perspective view schematically showing the configuration of a long optical pulse stretcher (L-OPS) according to the first embodiment.

FIG. 5 is a perspective view schematically showing the configuration of the L-OPS according to a second embodiment.

FIG. 6 is a diagram schematically showing a propagation operation of pulse laser light as replacing a pair of concave mirrors with a pair of convex lenses.

FIG. 7 shows a first modification of a beam rotation mechanism applied to the L-OPS.

FIG. 8 shows a second modification of the beam rotation mechanism applied to the L-OPS.

FIG. 9 is a top view schematically showing the configuration of the laser device according to a third embodiment.

FIG. 10 is a front view schematically showing the configuration of the laser device according to the third embodiment.

FIG. 11 is a perspective view schematically showing the configuration of the L-OPS according to the third embodiment.

FIG. 12 schematically shows a configuration example of an exposure apparatus.

### DESCRIPTION OF EMBODIMENTS

### <Contents>

1. Overview of laser device according to comparative example

1.1 Configuration

1.2 Operation

1.3 Problem

### 2. First Embodiment

2.1 Configuration

2.2 Operation

2.3 Specific Example of L-OPS
2.3.1 Configuration
2.3.2 Operation

2.4 Effect

2.5 Modification

### 3. Second Embodiment

3.1 Configuration

3.2 Operation

3.3 Effect

4. First modification of beam rotation mechanism

4.1 Configuration

4.2 Operation

4.3 Effect

5. Second modification of beam rotation mechanism

5.1 Configuration

5.2 Operation

5.3 Effect

### 6. Third Embodiment

6.1 Configuration

6.2 Operation

6.3 Specific Example of L-OPS
6.3.1 Configuration
6.3.2 Operation

6.4 Effect

6.5 Modification

7. Electronic device manufacturing method

### 8. Others

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numerals, and duplicate description thereof is omitted.

### 1. Overview of Laser Device According to Comparative Example

### 1.1 Configuration

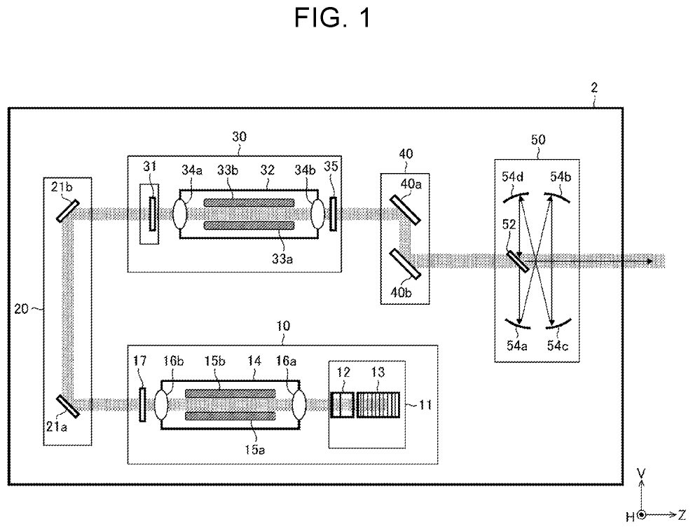

FIG. 1 schematically shows a configuration example of a laser device 2 according to a comparative example. The comparative example of the present disclosure is an example recognized by the applicant as known only by the applicant, and is not a publicly known example admitted by the applicant. The laser device 2 includes a master oscillator (MO) 10, a MO beam steering unit 20, a power oscillator (PO) 30, a PO beam steering unit 40, and an optical pulse stretcher (OPS)

The master oscillator 10 includes a line narrowing module (LNM) 11, a chamber 14, and an output coupling mirror (Output Coupler: OC) 17.

The LNM 11 includes a prism beam expander 12 for narrowing the spectral line width and a grating 13. The prism beam expander 12 and the grating 13 are arranged in the Littrow arrangement so that an incident angle and a diffraction angle coincide with each other.

The output coupling mirror 17 is a reflection mirror having a reflectance of 40% to 60%. The output coupling mirror 17 and the LNM 11 are arranged to configure an optical resonator.

The chamber 14 is arranged on the optical path of the optical resonator. The chamber 14 includes a pair of discharge electrodes 15a, 15b, and two windows 16a, 16b through which pulse laser light is transmitted. The chamber 14 contains an excimer laser gas. The excimer laser gas may include, for example, an Ar gas or a Kr gas as a rare gas, an F₂ gas as a halogen gas, and an Ne gas as a buffer gas.

The MO beam steering unit 20 includes a high reflection mirror 21a and a high reflection mirror 21b. The high reflection mirror 21a and the high reflection mirror 21b are arranged such that the pulse laser light output from the master oscillator 10 enters the power oscillator 30.

The power oscillator 30 includes a rear mirror 31, a chamber 32, and an output coupling mirror 35. The rear mirror 31 and the output coupling mirror 35 are arranged to configure an optical resonator.

The chamber 32 is arranged on the optical path of the optical resonator. The chamber 32 may have a configuration similar to that of the chamber 14 of the master oscillator 10. That is, the chamber 32 includes a pair of discharge electrodes 33a, 33b, and two windows 34a, 34b through which pulse laser light is transmitted. The chamber 32 contains the excimer laser gas.

The rear mirror 31 is a reflection mirror having a reflectance of 50% to 90%. The output coupling mirror 35 is a reflection mirror having a reflectance of 10% to 30%.

The PO beam steering unit 40 includes a high reflection mirror 40a and a high reflection mirror 40b. The high reflection mirror 40a and the high reflection mirror 40b are arranged such that the pulse laser light output from the power oscillator 30 enters the OPS 50.

The OPS 50 includes a beam splitter 52 and four concave mirrors 54a to 54d. The beam splitter 52 is arranged on the optical path of the pulse laser light output from the PO beam steering unit 40. The beam splitter 52 is a reflection mirror which transmits a part of the incident pulse laser and reflects the other thereof. The reflectance of the beam splitter 52 is preferably 40% to 70%, and more preferably about 60%. The beam splitter 52 causes the pulse laser light transmitted through the beam splitter 52 to be output from the laser device 2.

The four concave mirrors 54a to 54d configure a delay optical path of the pulse laser light reflected by a first surface of the beam splitter 52. The pulse laser light reflected by the first surface of the beam splitter 52 is reflected by the four concave mirrors 54a to 54d, and the beam is focused again on the beam splitter 52.

The four concave mirrors 54a to 54d may be concave mirrors all having substantially the same focal length. The focal length f of each of the concave mirrors 54a to 54d may correspond to, for example, the distance from the beam splitter 52 to the concave mirror 54a.

The concave mirror 54a and the concave mirror 54b are arranged such that the pulse laser light reflected by the first surface of the beam splitter 52 is reflected by the concave mirror 54a to be incident on the concave mirror 54b. The concave mirror 54a and the concave mirror 54b are arranged such that the pulse laser light reflected by the first surface of the beam splitter 52 is focused as a first transfer image at magnification equal (1:1) to the image on the first plane of the beam splitter 52.

The concave mirror 54c and the concave mirror 54d are arranged such that the pulse laser light reflected by the concave mirror 54b is reflected by the concave mirror 54c to be incident on the concave mirror 54d. Further, the concave mirror 54d is arranged such that the pulse laser light reflected by the concave mirror 54d is incident on a second surface of the beam splitter 52 on the opposite side to the first surface. The concave mirror 54c and the concave mirror 54d are arranged such that the first transfer image is focused on the second surface of the beam splitter 52 at 1:1 as a second transfer image.

### 1.2 Operation

When discharge occurs in the chamber 14 of the master oscillator 10, the laser gas is excited, and pulse laser light line-narrowed by the optical resonator configured by the output coupling mirror 17 and the LNM 11 is output from the output coupling mirror 17. The pulse laser light is incident on the rear mirror 31 of the power oscillator 30 as seed light by the MO beam steering unit 20.

Discharge occurs in the chamber 32 in synchronization with the timing when the seed light transmitted through the rear mirror 31 enters. As a result, the laser gas is excited, the seed light is amplified by the Fabry-Perot optical resonator configured by the output coupling mirror 35 and the rear mirror 31, and the amplified pulse laser light is output from the output coupling mirror 35. The pulse laser light output from the output coupling mirror 35 enters the OPS 50 via the PO beam steering unit 40.

The pulse laser light having entered the OPS 50 is incident on the first surface of the beam splitter 52. A part of the pulse laser light incident on the first surface of the beam splitter 52 is transmitted through the beam splitter 52 and is output from the OPS 50 as the pulse laser light of zero-circulation light (through light) without having circulated in the delay optical path.

Among the pulse laser light incident on the first surface of the beam splitter 52, the pulse laser light reflected by the first surface of the beam splitter 52 enters the delay optical path, and is reflected by the concave mirror 54a and the concave mirror 54b. The optical image of the pulse laser light reflected by the first surface of the beam splitter 52 is focused as the first transfer image at 1:1 by the concave mirror 54a and the concave mirror 54b. The first transfer image is focused on the second surface of the beam splitter 52 at 1:1 by the concave mirror 54c and the concave mirror 54d as the second transfer image.

A part of the pulse laser light incident on the second surface of the beam splitter 52 from the concave mirror 54d is reflected by the second surface of the beam splitter 52, and is output from the OPS 50 as the pulse laser light of one-circulation light having circulated once in the delay optical path. The pulse laser light of the one-circulation light is output with delay of a delay time Δt1 from the pulse laser light of zero-circulation light. The delay time Δt1 can be expressed as Δt1=LOPS/c where LOPS represents the optical path length of the delay optical path of the OPS 50 and c represents the speed of light.

Among the pulse laser light incident on the second surface of the beam splitter 52 as the second transfer image, the pulse laser light transmitted through the beam splitter 52 further enters the delay optical path, is reflected by the four concave mirrors 54a, 54b, 54c, 54d, and is incident again on the second surface of the beam splitter 52. Then, the pulse laser light reflected by the second surface of the beam splitter 52 is output from the OPS 50 as the pulse laser light of the two-circulation light having circulated twice in the delay optical path. The pulse laser light of the two-circulation light is output with delay of a delay time Δt1 from the pulse laser light of one-circulation light.

Thereafter, by repeating the light circulation in the delay optical path, pulse laser light of zero-circulation light, that of one-circulation light, that of two-circulation light, that of three-circulation light, . . . are output from the OPS 50. The light intensity of the pulse laser light output from the OPS 50 decreases as the number of circulations in the delay optical path increases.

The pulse laser light of one-circulation light and that thereafter are delayed each by an integer multiple of the delay time Δt1 with respect to the pulse laser light of zero-circulation light and are combined and output, so that the pulse waveforms thereof are superimposed. Thus, the pulse width of the pulse laser light is extended by the OPS 50.

The pulse laser light having passed through the OPS 50 passes through a monitor module (not shown) and is output from the laser device 2. The monitor module includes a beam splitter (not shown) and a sensor (not shown), and measures pulse energy, spectral line width, wavelength, and the like of the pulse laser light.

Although FIG. 1 shows an example in which the OPS 50 as one stage is provided, the laser device 2 may include OPSs as two or more stages. For example, one or more OPSs (not shown) may be arranged in series on the optical path of the pulse laser light output from the OPS 50.

### 1.3 Problem

The laser device 2 extends the pulse width of the pulse laser light by the OPS 50, thereby suppressing occurrence of unevenness (speckle) on the surface of a workpiece. When the workpiece is a wafer, speckle appears as being scattered on a wafer surface, so that the variation of the exposure amount occurs partially to change the size of the exposure pattern. Speckle is the light and dark spots caused by interference when pulse laser light is scattered to homogenize the optical intensity distribution of the pulse laser light. An image obtained by photographing the light and dark spots is referred to as a speckle image. As a speckle evaluation index, the following speckle contrast SC is generally used.

SC=σ(I)/Avg (I)

Here, σ(I) is a standard deviation of intensity I in a speckle image and Avg(I) is an average value of the intensity I.

In order to further extend the pulse width by the OPS to reduce the speckle contrast, a long OPS for forming an extremely large optical path difference is required. When the optical path length is increased while the pulse laser light is reflected by a plurality of mirrors in order to configure the long OPS, the beam divergence in the direction parallel to the plane including a propagation optical path configured by the plurality of mirrors increases, and the specifications of the pulse laser light required by the exposure apparatus may not be satisfied.

In FIG. 1, description will be provided by introducing an orthogonal coordinate system in which the height direction of the laser device 2 (the vertical direction in FIG. 1) is defined as a V-axis direction, the length direction of the laser device 2 (the horizontal direction in FIG. 1) is defined as a Z-axis direction, and the depth direction of the laser device 2 (the direction perpendicular to a paper surface of FIG. 1) is defined an H-axis direction. In the laser device 2 shown in FIG. 1, the concave mirrors 54a to 54d of the OPS 50 are arranged so as to form a propagation optical path (delay optical path) in a plane parallel to the VZ plane including the V axis and the Z axis.

In configuring an OPS that forms a longer optical path difference, for example, in a case in which a plurality of concave mirrors (not shown) are further arranged along the VZ plane ahead of or behind the OPS 50 to form a propagation optical path in the VZ plane, the pulse laser light output from the laser device 2 has a large beam divergence in the V-axis direction parallel to the VZ plane.

The beam divergence of the pulse laser light to enter the exposure apparatus is required to satisfy the specifications defined by the exposure apparatus. Therefore, when a longer OPS is used in place of or in addition to the OPS 50, it is required to configure the OPS so that pulse laser light satisfying the requirements of the exposure apparatus can be obtained.

In addition, since the space in and around the laser device is limited, space-saving is required for the long OPS.

### 2. First Embodiment

### 2.1 Configuration

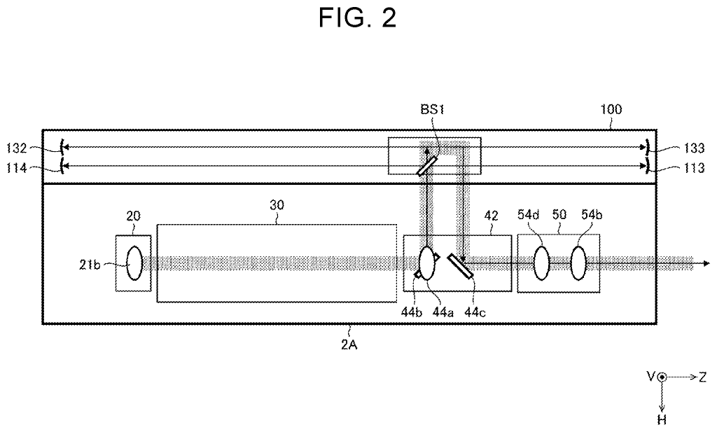

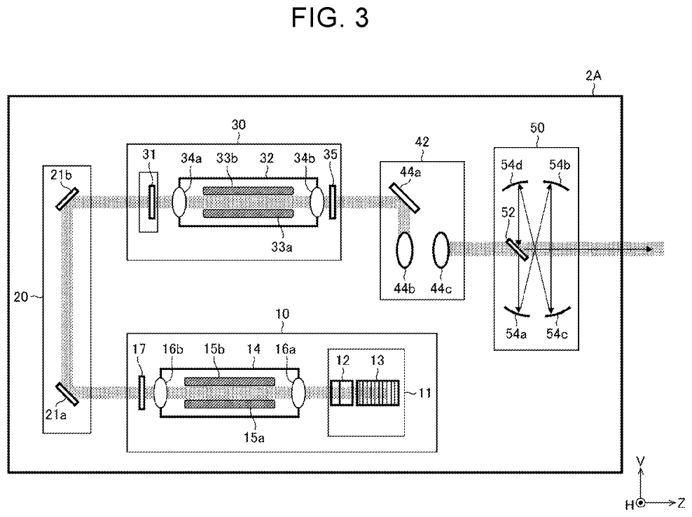

FIG. 2 is a top view schematically showing the configuration of a laser device 2A according to a first embodiment, and FIG. 3 is a front view schematically showing the configuration of the laser device 2A. The “front side” of the laser device 2A refers to a side, among the outer peripheral face of the laser device 2A, where an outer cover panel (not shown) is widely opened for maintenance or the like of the laser device 2A. The “front side” represents the side where the arrangement structure inside the device as shown in FIG. 3 can be seen when the outer cover panel of the laser device 2A is opened.

In FIGS. 2 and 3, the same orthogonal coordinate system as that of FIG. 1 is applied, and the height direction of the laser device 2A is defined as the V-axis direction, the length direction of the laser device 2A is defined as the Z-axis direction, and the depth direction of the laser device 2A is defined as the H-axis direction. The V-axis direction may be parallel to the gravity direction, a direction opposite to the gravity direction is referred to as the “+V direction”, and the gravity direction is referred to as the “−V direction.”

The laser device 2A has a substantially rectangular parallelepiped outer shape, and a beam outlet (not shown) of the laser device 2A is provided on the side surface on the right side in FIG. 3. The output direction of the pulse laser light output from the laser device 2A is referred to as the “+Z direction.” A direction toward the front of the paper surface of FIG. 3 is referred to as the “+H direction.”

The laser device 2A includes the master oscillator 10, the MO beam steering unit 20, the power oscillator 30, and the OPS 50. These elements may have the similar configuration as that of the laser device 2 shown in FIG. 1. The master oscillator 10 or the combination of the master oscillator 10 and the power oscillator 30 is an example of the “laser oscillator” in the present disclosure. The laser device 2A shown in FIGS. 2 and 3 will be described in terms of differences from the comparative example shown in FIG. 1.

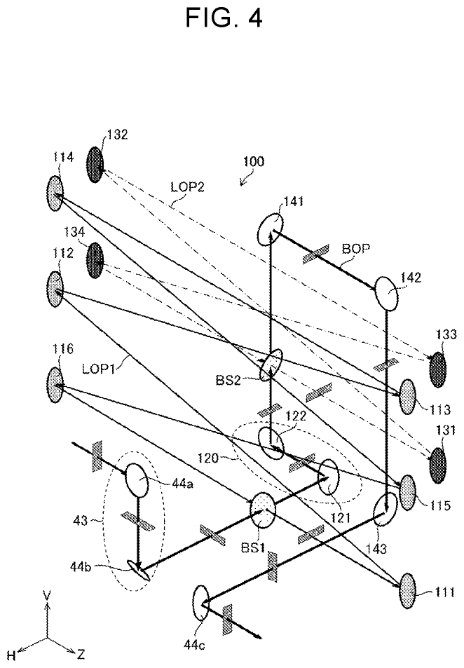

The laser device 2A includes a long optical pulse stretcher 100 (hereinafter, referred to as the “L-OPS 100”) for forming a long optical path difference to extend the pulse width. The L-OPS 100 is located on the back side of the laser device 2A. The “back side” is the back side when viewed from the front side, and is the side opposite to the front side. A specific configuration example of the L-OPS 100 will be described later with reference to FIG. 4. The laser device 2A includes a PO beam steering unit 42 in place of the PO beam steering unit 40 of FIG. 1.

The PO beam steering unit 42 includes a high reflection mirror 44a, a high reflection mirror 44b, and a high reflection mirror 44c for light traveling with the L-OPS 100.

The high reflection mirror 44a is arranged such that the pulse laser light output from the power oscillator 30 is reflected to be incident on the high reflection mirror 44b. The high reflection mirror 44b is arranged such that the pulse laser light reflected by the high reflection mirror 44a is reflected to be incident on a first beam splitter BS1 of the L-OPS 100. The high reflection mirror 44c is arranged such that the pulse laser light output from the L-OPS 100 is reflected to enter the OPS 50.

### 2.2 Operation

The pulse laser light output from the power oscillator 30 is changed in propagation direction by the high reflection mirror 44a and the high reflection mirror 44b of the PO beam steering unit 42 to enter the L-OPS 100 on the back side of the laser device 2A.

The pulse laser light having entered the L-OPS 100 is extended in pulse width by the L-OPS 100 and returns to the PO beam steering unit 42.

The pulse laser light having returned to the PO beam steering unit 42 is changed in propagation direction by the high reflection mirror 44c to enter the OPS 50. The pulse laser light having entered the OPS 50 is further extended in pulse width by the OPS 50 and is output from the laser device 2A.

### 2.3 Specific Example of L-OPS

### 2.3.1 Configuration

FIG. 4 is a perspective view schematically showing the configuration of the L-OPS 100. The L-OPS 100 includes the first beam splitter BS1, a plurality of concave mirrors 111 to 116, high reflection mirrors 121, 122, a second beam splitter BS2, a plurality of concave mirrors 131 to 134, and high reflection mirrors 141 to 143.

The first beam splitter BS1 and the plurality of concave mirrors 111 to 116 configure a first delay optical system including a first loop optical path LOP1. The high reflection mirror 121 and the high reflection mirror 122 configure a beam rotation mechanism 120 to rotate the beam of the pulse laser light. The second beam splitter BS2 and the plurality of concave mirrors 131 to 134 configure a second delay optical system including a second loop optical path LOP2. The high reflection mirrors 141 to 143 configure a return propagation optical path BOP that returns the pulse laser light having passed through the first loop optical path LOP1 and the second loop optical path LOP2 to the PO beam steering unit 42.

In FIG. 4, the optical path of the pulse laser light propagating via the high reflection mirrors 44a, 44b, 121, 122, 141, 142, 143, and 44c is indicated by a thick solid line, the first loop optical path LOP1 is indicated by a thin solid line, and the second loop optical path LOP2 is indicated by a one dot chain line.

In FIG. 4, each of the rectangular marks shown on the optical path of the pulse laser light schematically represents a beam cross-sectional shape of the pulse laser light propagating through the optical path. The “beam cross-sectional shape” is the shape of the cross-sectional profile of the beam cross section perpendicular to the beam axis. Hereinafter, the term “beam cross section” is used as a term synonymous with “beam cross-sectional profile” or “beam cross-sectional shape.” The long-side direction of the rectangle is the longitudinal direction of the beam cross section, and the short-side direction of the rectangle is the short-length direction of the beam cross section.

For example, the pulse laser light incident on the high reflection mirror 44a has a vertically long beam shape in which the longitudinal direction of the beam cross section is parallel to the V-axis direction. The high reflection mirror 44a is arranged such that the incident pulse laser light is reflected in the V-axis direction (−V direction in FIG. 4) to be incident on the high reflection mirror 44b. The high reflection mirror 44b is arranged such that the pulse laser light from the high reflection mirror 44a is reflected in the H-axis direction (−H direction in FIG. 4) to enter the first beam splitter BS1 of the L-OPS 100. The pulse laser light output from the high reflection mirror 44b has a horizontally long beam shape in which the longitudinal direction of the beam cross section is perpendicular to the V-axis direction.

The combination of the high reflection mirror 44a and the high reflection mirror 44b configures a beam rotation mechanism 43 to rotate the beam of the pulse laser light so as to convert a vertically long beam into a horizontally long beam. Here, the description “rotate” includes the meaning of adjusting the orientation of the longitudinal direction and the short-length direction of the beam cross section with respect to the beam axis.

The first beam splitter BS1 is arranged on the optical path between the high reflection mirror 44b and the high reflection mirror 121. The concave mirrors 111 to 116 form the first loop optical path LOP1 serving as a delay optical path through which the pulse laser light reflected by the first beam splitter BS1 propagates. The concave mirrors 111 to 116 may be concave mirrors having substantially the same focal length. The focal length f1 of each of the concave mirrors 111 to 116 may correspond to, for example, the distance from the first beam splitter BS1 to the concave mirror 111. The pulse laser light reflected by the first beam splitter BS1 is reflected by the concave mirrors 111, 112, 113, 114, 115, and 116 in this order, and the beam is focused again on the first beam splitter BS1.

In FIG. 4, the first loop optical path LOP1 is formed on the same plane parallel to the VZ plane. That is, the first beam splitter BS1 and the concave mirrors 111 to 116 are arranged such that the first loop optical path LOP1 is formed on the same plane parallel to the VZ plane. It should be noted that the description of the “same plane” may include a tolerance to the extent that it can be regarded as substantially the same plane. Further, “the optical paths are formed on the same plane” may be rephrased as “the plane including the optical paths is a single plane” or “the optical paths are formed in the same plane.” The plane on which the first loop optical path LOP1 is formed is referred to as a “first loop optical path plane.” The first loop optical path plane may be rephrased as a plane including the first loop optical path LOP1. The first loop optical path plane is an example of the “first plane” in the present disclosure.

The high reflection mirror 121 is arranged such that the pulse laser light output from the first beam splitter BS1 is reflected to be incident on the high reflection mirror 122. The high reflection mirror 122 is arranged such that the pulse laser light incident from the high reflection mirror 121 is reflected to enter the second beam splitter BS2.

The second beam splitter BS2 is arranged on the optical path between the high reflection mirror 122 and the high reflection mirror 141. Here, the second beam splitter BS2 may be arranged on the optical path between the high reflection mirror 142 and the high reflection mirror 143.

The concave mirrors 131 to 134 form the second loop optical path LOP2 serving as a delay optical path through which the pulse laser light reflected by the second beam splitter BS2 propagates. The concave mirrors 131 to 134 may be concave mirrors all having substantially the same focal length. The focal length f2 of each of the concave mirrors 131 to 134 may correspond to, for example, the distance from the second beam splitter BS2 to the concave mirror 131. The pulse laser light reflected by the second beam splitter BS2 is reflected by the concave mirrors 131, 132, 133, and 134 in this order, and the beam is focused again on the second beam splitter BS2.

The second loop optical path LOP2 is formed on a plane parallel to the VZ plane. The plane on which the second loop optical path LOP2 is formed is referred to as a second loop optical path plane. The second loop optical path plane may be rephrased as a plane including the second loop optical path LOP2. The second loop optical path plane is parallel to and different from (non-identical to) the first loop optical path plane. That is, the second beam splitter BS2 and the concave mirrors 131 to 134 are arranged such that the second loop optical path LOP2 is formed on the same plane parallel to the VZ plane. The second loop optical path plane is an example of the “second plane” in the present disclosure.

The concave mirrors 111, 115, 113, 131, and 133 and the concave mirrors 116, 112, 114, 134, and 132 are arranged respectively at both ends of the laser device 2A in the longitudinal direction so as to face each other. The longitudinal direction of the laser device 2A is the horizontal direction (Z-axis direction) in FIG. 2.

That is, the concave mirror 111, the concave mirror 115, and the concave mirror 113 are arranged in line along the V-axis direction in this order at one end (end on the right side in FIG. 2, hereinafter referred to as a first end) in the longitudinal direction of the laser device 2A. The concave mirror 116, the concave mirror 112, and the concave mirror 114 are arranged in line along the V-axis direction in this order at the other end (end on the left side in FIG. 2, hereinafter referred to as a second end) in the longitudinal direction of the laser device 2A. The concave mirror 111 and the concave mirror 116 are arranged at positions facing each other across the first beam splitter BS1.

Similarly, the concave mirror 131 and the concave mirror 133 are arranged in this order in line along the V-axis direction at the first end of the laser device 2A in the longitudinal direction. The concave mirror 134 and the concave mirror 132 are arranged in this order in line along the V-axis direction at the second end of the laser device 2A in the longitudinal direction. The concave mirror 131 and the concave mirror 134 are arranged at positions facing each other across the second beam splitter BS2.

The propagation optical path of the beam rotation mechanism 120 configured by the high reflection mirrors 121, 122 and the return propagation optical path BOP configured by the high reflection mirrors 141 to 143 are formed on the same plane as the second loop optical path LOP2. That is, the high reflection mirrors 121, 122 and the high reflection mirrors 141 to 142 are arranged such that the propagation optical path along which the pulse laser light enters the second beam splitter BS2 from the high reflection mirror 121 via the high reflection mirror 122 and the return propagation optical path BOP from the second beam splitter BS2 to the high reflection mirror 143 via the high reflection mirrors 141, 142 are formed on the second loop optical path plane.

The L-OPS 100 is an example of the “pulse width extension device” in the present disclosure. The beam rotation mechanism 120 is an example of the “first beam rotation mechanism” in the present disclosure. The high reflection mirror 121 and the high reflection mirror 122 are examples of the “two or more mirrors” configuring the “first beam rotation mechanism” in the present disclosure, and each of the high reflection mirrors 121, 122 is an example of the “mirror” configuring the “first beam rotation mechanism” in the present disclosure. The beam rotation mechanism 43 is an example of the “second beam rotation mechanism” in the present disclosure. The high reflection mirror 44a and the high reflection mirror 44b are examples of the “two or more mirrors” configuring the “second beam rotation mechanism” in the present disclosure, and each of the high reflection mirrors 44a, 44b is an example of the “mirror” configuring the “second beam rotation mechanism” in the present disclosure. The high reflection mirrors 141 to 143 are examples of the “return propagation optical system” in the present disclosure, and the return propagation optical path BOP is an example of the “optical path formed in the return propagation optical system” in the present disclosure.

The H-axis direction is an example of the “first axis direction” in the present disclosure. The Z-axis direction is an example of the “second axis direction” in the present disclosure. The V-axis direction is an example of the “third axis direction” in the present disclosure. Each of the concave mirrors 111 to 116 is an example of the “first concave mirror” in the present disclosure. Each of the concave mirrors 131 to 134 is an example of the “second concave mirror” in the present disclosure.

### 2.3.2 Operation

The beam rotation mechanism 43 configured by the high reflection mirrors 44a, 44b of the PO beam steering unit 42 rotates the beam of the pulse laser light such that the longitudinal direction of the beam cross section of the pulse laser light traveling on the first loop optical path LOP1 is perpendicular to the first loop optical path plane.

The pulse laser light output from the beam rotation mechanism 43 enters the first beam splitter BS1. The pulse laser light reflected by the first surface of the first beam splitter BS1 is reflected by the concave mirror 111, the concave mirror 112, the concave mirror 113, the concave mirror 114, the concave mirror 115, and the concave mirror 116 in this order, and propagates through the first loop optical path LOP1. The pulse laser light propagating through the first loop optical path LOP1 circulates in the first loop optical path LOP1 while maintaining the beam shape in which the longitudinal direction of the beam cross section is perpendicular to the first loop optical path plane.

That is, the pulse laser light propagating through the first loop optical path LOP1 circulates in the first loop optical path LOP1 while maintaining the beam shape in which the short-length direction of the beam cross section is parallel to the first loop optical path plane.

The pulse laser light propagating through the first loop optical path LOP1 enters again the first beam splitter BS1 from the concave mirror 116. Among the pulse laser light having circulated in the first loop optical path LOP1 and reentered the first beam splitter BS1, the pulse laser light transmitted through the second surface of the first beam splitter BS1 propagates again through the first loop optical path LOP1.

On the other hand, among the pulse laser light having circulated in the first loop optical path LOP1 and reentered the first beam splitter BS1, the pulse laser light reflected by the second surface of the first beam splitter BS1 is combined with the pulse laser light of zero-circulation light transmitted through the first surface of the first beam splitter BS1 and is incident on the high reflection mirror 121 of the beam rotation mechanism 120.

The pulse laser light having entered the beam rotation mechanism 120 is reflected by the high reflection mirrors 121, 122, and the beam of the pulse laser light is rotated such that the longitudinal direction of the beam cross section of the pulse laser light propagating through the second loop optical path LOP2 is perpendicular to the second loop optical path plane.

The pulse laser light output from the beam rotation mechanism 120 is incident on the first surface of the second beam splitter BS2, and the pulse laser light reflected by the first surface of the second beam splitter BS2 propagates through the second loop optical path LOP2. The pulse laser light transmitted through the first surface of the second beam splitter BS2 is output from the second beam splitter BS2 as zero-circulation light and is incident on the high reflection mirror 141. The pulse laser light propagating through the second loop optical path LOP2 enters again the second beam splitter BS2. Among the pulse laser light having circulated in the second loop optical path LOP2 and reentered the second beam splitter BS2, the pulse laser light transmitted through the second surface of the second beam splitter BS2 propagates again through the second loop optical path LOP2.

On the other hand, among the pulse laser light having circulated in the second loop optical path LOP2 and reentered the second beam splitter BS2, the pulse laser light reflected by the second surface of the second beam splitter BS2 leaves the second loop optical path LOP2 and is incident on the high reflection mirror 141. The pulse laser light incident on the high reflection mirror 141 from the second beam splitter BS2 is reflected by the high reflection mirrors 141, 142, 143 in this order and is returned to the high reflection mirror 44c of the PO beam steering unit 42. The pulse laser light reflected by the high reflection mirror 44c enters the OPS 50. The operation by the OPS 50 is as described with reference to FIG. 1.

The pulse laser light output from the OPS 50 enters the exposure apparatus (not shown). In the exposure apparatus, the condition of the beam divergence of the pulse laser light to be received by the exposure apparatus is determined in order to perform appropriate exposure on the workpiece.

The pulse laser light propagating through the first loop optical path LOP1 and the second loop optical path LOP2 in the L-OPS 100 propagates while being reflected by the plurality of concave mirrors 111 to 116 and the plurality of concave mirrors 131 to 134, so that the beam divergence in the short-length direction of the beam cross section is increased. However, the beam cross section has a larger margin in the short-length direction than that in the longitudinal direction with respect to the specifications of the beam divergence required by the exposure apparatus. This is because the beam divergence in the short-length direction of the beam cross section of the pulse laser light output from the power oscillator 30 is smaller than the beam divergence in the longitudinal direction.

In the laser device 2A according to the first embodiment, the pulse laser light is caused to enter the first loop optical path LOP1 and the second loop optical path LOP2 with the beam of the pulse laser light rotated by the beam rotation mechanisms 43, 120 so that the short-length direction of the beam cross section having the large margin with respect to the requirement of the exposure apparatus is parallel to the loop optical path planes of the first loop optical path LOP1 and the second loop optical path LOP2.

### 2.4 Effect

According to the L-OPS 100 and the laser device 2A including the same in the first embodiment, the following effects can be obtained.

(1) Since the pulse laser light passes through the first loop optical path LOP1 and the second loop optical path LOP2 of the L-OPS 100, the pulse width can be greatly extended. According to the laser device 2A, it is possible to generate laser light with the pulse width extended and to reduce speckle contrast.

(2) By rotating the beam by the beam rotation mechanisms 43, 120 so that the longitudinal direction of the beam cross section of the pulse laser light is perpendicular to each of the first loop optical path LOP1 and the second loop optical path LOP2, the short-length direction of the beam cross section having the large margin with respect to the specifications becomes parallel to the plane including the propagation optical path, and the influence of the beam divergence expansion can be relatively reduced.

(3) By arranging, on the same plane, the second loop optical path LOP2, the incidence optical path through which the pulse laser light enters the second loop optical path LOP2 from the high reflection mirror 121, and the return propagation optical path BOP, it is possible to reduce the space in the thickness direction of the L-OPS 100 (the H-axis direction in FIGS. 2 to 4).

(4) By arranging the L-OPS 100 on the back side of the laser device 2A, it is not necessary to change the total height (the size in the V-axis direction in FIG. 3) of the laser device 2A body from that of the laser device 2 of the comparative example.

(5) By arranging the L-OPS 100 on the back side of the laser device 2A, the assembling property and the adjusting property are improved.

### 2.5 Modification

In the first embodiment, the configuration in which the pulse laser light enters the L-OPS 100 from the PO beam steering unit 42 and the pulse laser light whose pulse width is extended in the L-OPS 100 is returned to the PO beam steering unit 42 has been described. However, a part or all of the PO beam steering unit 42 may be included in the configuration of the L-OPS 100. For example, the beam rotation mechanism 43 shown in FIG. 4 may be included in the configuration of the L-OPS 100.

FIG. 4 shows an example in which the first loop optical path LOP1 is configured using the six concave mirrors 111 to 116. However, the number of concave mirrors configuring the first loop optical path LOP1 is not limited to this example. The number of concave mirrors configuring the first loop optical path LOP1 is preferably an even number, and more preferably an even number being four or more.

Similarly, FIG. 4 shows an example in which the second loop optical path LOP2 is configured using the six concave mirrors 131 to 134. However, the number of concave mirrors configuring the second loop optical path LOP2 is not limited to this example. The number of concave mirrors configuring the second loop optical path LOP2 is preferably an even number, and more preferably an even number being four or more.

Assuming that the number of concave mirrors configuring the first loop optical path LOP1 is 2n, the 2n concave mirrors configuring the first loop optical path LOP1 are divided into rows each having n concave mirrors, and the rows each having n concave mirrors are arranged as being separated in the Z-axis direction to face each other. In the mirror row on each side of the facing arrangement, the n concave mirrors are arranged side by side in the V-axis direction. Here, n is an integer of two or more.

Similarly, assuming that the number of concave mirrors configuring the second loop optical path LOP2 is 2m, the 2m concave mirrors configuring the second loop optical path LOP2 are divided into rows each having m concave mirrors, and the rows each having m concave mirrors are arranged as being separated in the Z-axis direction to face each other. In the mirror row on each side of the facing arrangement, the m concave mirrors are arranged side by side in the V-axis direction. Here, m is an integer of two or more. FIG. 4 shows an example in which n=3 and m=2.

### 3. Second Embodiment

### 3.1 Configuration

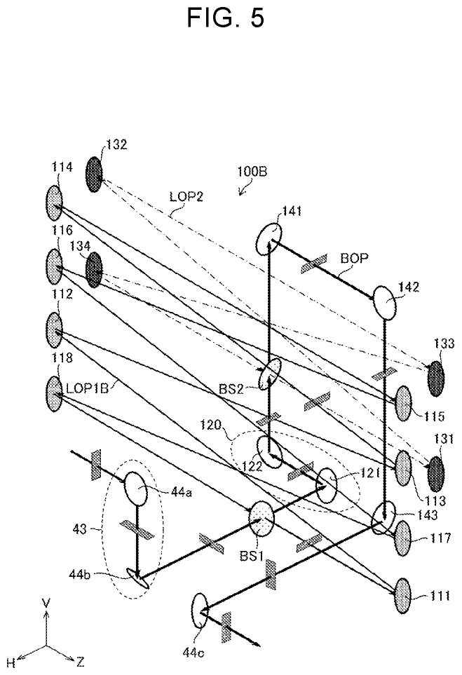

FIG. 5 is a perspective view schematically showing the configuration of an L-OPS 100B according to a second embodiment. The L-OPS 100B shown in FIG. 5 may be employed instead of the L-OPS 100 shown in FIG. 4. The configuration shown in FIG. 5 will be described in terms of differences from the configuration shown in FIG. 4.

The L-OPS 100B shown in FIG. 5 includes eight concave mirrors 111 to 118 instead of the six concave mirrors 111 to 116 described with reference to FIG. 4. The concave mirrors 111 to 118 configure a first loop optical path LOP1B serving as a delay optical path through which the pulse laser light reflected by the first beam splitter BS1 propagates. The concave mirrors 111 to 118 may be concave mirrors having substantially the same focal length. The pulse laser light reflected by the first beam splitter BS1 is reflected by the concave mirrors 111, 112, 113, 114, 115, 116, 117, and 118 in this order, and the beam is focused again on the first beam splitter BS1.

In the L-OPS 100 described with reference to FIG. 4, the first loop optical path LOP1 is configured using the six concave mirrors 111 to 116, whereas in the L-OPS 100B shown in FIG. 5, the first loop optical path LOP1B is configured using the eight concave mirrors 111 to 118.

That is, in the L-OPS 100B shown in FIG. 5, the eight concave mirrors configure the first loop optical path LOP1B and the four concave mirrors configure the second loop optical path LOP2, and the concave mirrors 111 to 118 and the concave mirrors 131 to 134 are arranged such that the concave mirrors arranged to face each other in the longitudinal direction of the laser device 2A are separated in rows, the number of the concave mirrors in each row being an even number.

As shown in FIG. 5, the concave mirrors 111, 117, 113, 115 and the concave mirrors 118, 112, 116, 114 are arranged respectively at both ends of the laser device 2A in the longitudinal direction (Z-axis direction) so as to face each other. The concave mirrors 111, 117, 113, 115 are arranged in line along the V-axis direction in this order at the first end of the laser device 2A in the longitudinal direction. The concave mirrors 118, 112, 116, 114 are arranged in line along the V-axis direction in this order at the second end of the laser device 2A in the longitudinal direction. The concave mirror 111 and the concave mirror 118 are arranged at positions facing each other across the first beam splitter BS1. The concave mirror 117 and the concave mirror 112 face each other, the concave mirror 113 and the concave mirror 116 face each other, and the concave mirror 115 and the concave mirror 114 face each other. The first loop optical path LOP1B is formed on the same plane parallel to the VZ plane. Other configurations may be similar to those shown in FIG. 4.

The number of concave mirrors configuring the second loop optical path LOP2 is four as in FIG. 4, and the concave mirrors arranged to face each other in the longitudinal direction of the laser device 2A are separated in rows, the number of the concave mirrors in each row being an even number.

### 3.2 Operation

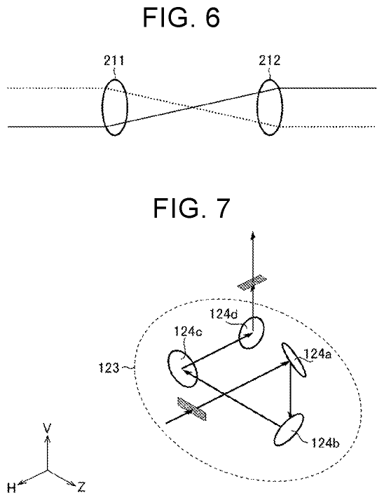

In the first loop optical path LOP1B, the pulse laser light propagates while the image is inverted by a pair of concave mirrors. FIG. 6 is a diagram schematically showing propagation operation of the pulse laser light using a pair of concave mirrors. In FIG. 6, the pair of concave mirrors is replaced with a pair of convex lenses. The convex lens 211 and the convex lens 212 shown in FIG. 6 correspond to, for example, the concave mirror 111 and the concave mirror 112.

In the case with the first loop optical path LOP1B shown in FIG. 5, since the number of concave mirrors on each row of the concave mirrors 111 to 118 arranged to face each other in the Z-axis direction is an even number, the number of pairs of concave mirrors for image inversion is an even number, and the image of the pulse laser light (circulation light) propagating through the first loop optical path LOP1B when reentering at the first beam splitter BS1 is not inverted with respect to the pulse laser light of zero-circulation light (through light) transmitted through the first beam splitter BS1. That is, it is only required that an even number of pairs of concave mirrors for image inversion are arranged, and the concave mirrors 111 to 118 shown in FIG. 5 are examples in which four pairs of concave mirrors for image inversion are arranged.

Similarly, in the case with the second loop optical path LOP2 shown in FIG. 5, since the number of concave mirrors on each row of the concave mirrors 131 to 134 arranged to face each other in the Z-axis direction is an even number, the number of pairs of concave mirrors for image inversion is an even number, and the image of the pulse laser light (circulation light) propagating through the second loop optical path LOP2 when reentering at the second beam splitter BS2 is not inverted with respect to the pulse laser light of zero-circulation light (through light) transmitted through the second beam splitter BS2. The concave mirrors 131 to 134 shown in FIG. 5 are examples in which two pairs of concave mirrors for image inversion are arranged.

### 3.3 Effect

According to the L-OPS 100B of the second embodiment, since the image of the loop light is not inverted with respect to the through light in each of the first loop optical path LOP1B and the second loop optical path LOP2, the pointing of the loop light does not face in the direction opposite to the pointing of the through light, and it is possible to suppress an increase in apparent beam size and divergence when the loop light and the through light are superimposed.

### 4. First Modification of Beam Rotation Mechanism

### 4.1 Configuration

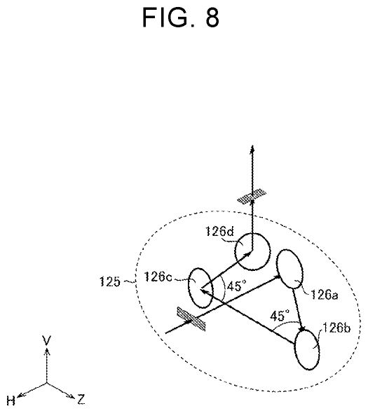

FIG. 7 shows a first modification of the beam rotation mechanism 120. Instead of the beam rotation mechanism 120 shown in FIGS. 4 and 5, a beam rotation mechanism 123 shown in FIG. 7 may be employed.

The beam rotation mechanism 123 may be configured by three or more high reflection mirrors. For example, the beam rotation mechanism 123 may be configured by four high reflection mirrors 124a, 124b, 124c, 124d.

The high reflection mirror 124a is arranged such that the pulse laser light having passed through the first loop optical path LOP1 (not shown in FIG. 7) is reflected to be incident on the high reflection mirror 124b. The high reflection mirror 124b is arranged such that the pulse laser light reflected by the high reflection mirror 124a is reflected to be incident on the high reflection mirror 124c. The high reflection mirror 124c is arranged such that the pulse laser light reflected by the high reflection mirror 124b is reflected to be incident on the high reflection mirror 124d. The high reflection mirror 124d is arranged such that the pulse laser light reflected by the high reflection mirror 124c is reflected to enter the second beam splitter BS2 (not shown in FIG. 7). The angle formed between incident light and reflection light (the sum of the incident angle and the reflection angle) of each of the high reflection mirrors 124a, 124b, 124c, 124d may be, for example, 90 degrees.

The beam rotation mechanism 123 is an example of the “first beam rotation mechanism” in the present disclosure. The high reflection mirrors 124a, 124b, 124c, 124d are examples of the “four or more mirrors” configuring the “first beam rotation mechanism” in the present disclosure.

### 4.2 Operation

The pulse laser light incident on the high reflection mirror 124a is reflected by the high reflection mirrors 124a, 124b, 124c, 124d in this order to be incident on the second beam splitter BS2.

The beam rotation mechanism 123 has a larger number of high reflection mirrors than the beam rotation mechanism 120 shown in FIG. 4 to cause the pulse laser light to propagate so as not to interfere with other devices (not shown), and rotates the beam of the pulse laser light so that the short-length direction of the beam cross section of the pulse laser light is parallel to the loop optical path plane in the second loop optical path LOP2.

### 4.3 Effect

By employing the beam rotation mechanism 123 according to the first modification, it is possible to provide appropriate mirror arrangement suitable for the surrounding space.

Further, according to the beam rotation mechanism 123 according to the first modification, it is possible to cause the pulse laser light to propagate so as not to interfere with other devices, and the delay optical path can be formed such that the short-length direction of the beam cross section of the pulse laser light is parallel to the loop optical path plane in the second loop optical path LOP2.

### 5. Second Modification of Beam Rotation Mechanism

### 5.1 Configuration

FIG. 8 shows a second modification of the beam rotation mechanism 120. Instead of the beam rotation mechanism 120 shown in FIGS. 4 and 5, a beam rotation mechanism 125 shown in FIG. 8 may be employed. The beam rotation mechanism 125 may be configured by four high reflection mirrors 126a, 126b, 126c, 126d.

The angle formed between incident light and reflection light of each of the mirrors configuring the beam rotation mechanism 125 may be other than 90 degrees. For example, the angle formed between the incident light and the reflection light of the high reflection mirror 126b and the angle formed between the incident light and the reflection light of the high reflection mirror 126c may each be 45 degrees.

The high reflection mirror 126a is arranged such that the pulse laser light having passed through the first loop optical path LOP1 (not shown in FIG. 8) is reflected to be incident on the high reflection mirror 126b. The high reflection mirror 126b is arranged such that the pulse laser light output from the high reflection mirror 126a is reflected at a reflection angle of 45 degrees to be incident on the high reflection mirror 126c. The high reflection mirror 126c is arranged such that the pulse laser light output from the high reflection mirror 126b is reflected at a reflection angle of 45 degrees to be incident on the high reflection mirror 126d. The high reflection mirror 126d is arranged such that the pulse laser light output from the high reflection mirror 126c is reflected to be incident on the second beam splitter BS2 (not shown in FIG. 8).

The beam rotation mechanism 125 is an example of the “first beam rotation mechanism” in the present disclosure. The high reflection mirrors 126a, 126b, 126c, 126d are examples of the “four or more mirrors” configuring the “first beam rotation mechanism” in the present disclosure.

### 5.2 Operation

The pulse laser light incident on the high reflection mirror 126a is reflected by the high reflection mirrors 126a, 126b, 126c, 126d in this order to be incident on the second beam splitter BS2.

The beam rotation mechanism 125 has more high reflection mirrors than the beam rotation mechanism 120 shown in FIG. 4 to cause the pulse laser light to propagate so as not to interfere with other devices (not shown), and rotates the beam of the pulse laser light so that the short-length direction of the beam cross section of the pulse laser light is parallel to the loop optical path plane in the second loop optical path LOP2.

### 5.3 Effect

In the beam rotation mechanism 125 according to the second modification as well, as in the first modification, appropriate mirror arrangement suitable for the surrounding space can be provided. Further, according to the beam rotation mechanism 125 according to the second modification, it is possible to cause the pulse laser light to propagate so as not to interfere with other devices, and the delay optical path can be formed such that the short-length direction of the beam cross section of the pulse laser light is parallel to the loop optical path plane in the second loop optical path LOP2.

### 6. Third Embodiment

### 6.1 Configuration

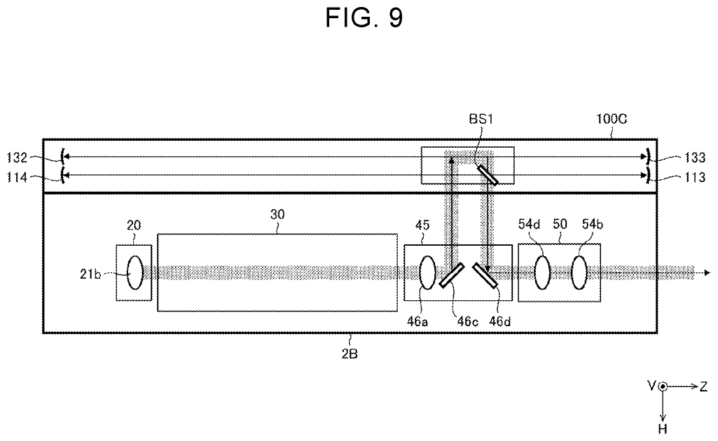

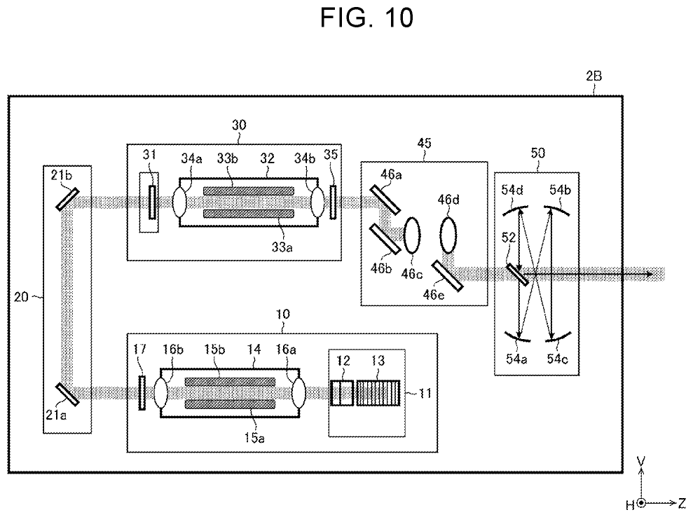

FIG. 9 is a top view schematically showing the configuration of a laser device 2B according to a third embodiment, and FIG. 10 is a front view schematically showing the configuration of the laser device 2B. The configuration of the laser device 2B will be described in terms of differences from the configuration shown in FIGS. 2 and 3.

The laser device 2B according to the third embodiment has the configuration in which the passing order of the pulse laser light through the first loop optical path LOP1 and the second loop optical path LOP2 of the L-OPS 100 arranged on the back side of the laser device 2A according to the first embodiment is reversed.

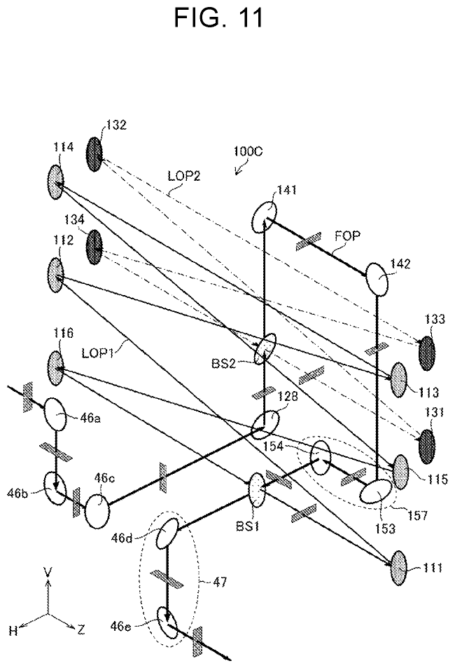

The detailed configuration of an L-OPS 100C arranged, instead of the L-OPS 100, on the back side of the laser device 2B will be described later with reference to FIG. 11.

By employing the configuration in which the passing order through the first loop optical path LOP1 and the second loop optical path LOP2 of the L-OPS 100 is switched in the L-OPS 100C, the longitudinal direction and the short-length direction of the beam cross section of each of the pulse laser light entering the L-OPS 100C and the pulse laser light output from the L-OPS 100C are changed from those in the case with the L-OPS 100. Therefore, the laser device 2B includes a PO beam steering unit 45 having a configuration different from that of the PO beam steering unit 40.

The PO beam steering unit 45 includes a high reflection mirror 46a, a high reflection mirror 46b, a high reflection mirror 46c, a high reflection mirror 46d, and a high reflection mirror 46e for light traveling with the L-OPS 100C.

The high reflection mirror 46a is arranged such that the pulse laser light output from the power oscillator 30 is reflected to be incident on the high reflection mirror 46b. The high reflection mirror 46b is arranged such that the pulse laser light output from the high reflection mirror 46a is reflected to be incident on the high reflection mirror 46c. The high reflection mirror 46c is arranged such that the pulse laser light output from the high reflection mirror 46b is reflected to enter the L-OPS 100C. The high reflection mirror 46d is arranged such that the pulse laser light output from the L-OPS 100C is reflected to be incident on the high reflection mirror 46e. The high reflection mirror 46e is arranged such that the pulse laser light output from the high reflection mirror 46d is reflected to enter the OPS 50.

### 6.2 Operation

The PO beam steering unit 45 adjusts the orientation of the longitudinal direction and the short-length direction of the beam cross section of the pulse laser light output from the power oscillator 30 using the high reflection mirrors 46a, 46b, 46c, and outputs the pulse laser light toward the L-OPS 100C. That is, the pulse laser light output from the power oscillator 30 is reflected by the high reflection mirrors 46a, 46b, 46c in this order to enter the L-OPS 100C.

The return light (extended pulse laser light) whose pulse width is extended by the L-OPS 100C and which is output from the L-OPS 100C toward the PO beam steering unit 45 is output toward the OPS 50 with the orientation of the longitudinal direction and the short-length direction of the beam cross section adjusted by the high reflection mirror 46d and the high reflection mirror 46e.

### 6.3 Specific Example of L-OPS

### 6.3.1 Configuration

FIG. 11 is a perspective view schematically showing the configuration of the L-OPS 100C according to the third embodiment. The configuration shown in FIG. 11 will be described in terms of differences from the configuration shown in FIG. 4.

The high reflection mirrors 46a, 46b, 46c are arranged instead of the beam rotation mechanism 43 shown in FIG. 4, and the pulse laser light from the power oscillator 30 is reflected by the high reflection mirrors 46a, 46b, 46c and enters the L-OPS 100C.

Further, the high reflection mirrors 46a, 46b shown in FIG. 11 may be omitted, and the pulse laser light from the power oscillator 30 may be caused to enter the L-OPS 100C by the single high reflection mirror 46c.

In the L-OPS 100C, only the high reflection mirror 128 is arranged instead of the beam rotation mechanism 120 of FIG. 4. The high reflection mirror 128 is arranged such that the pulse laser light output from the high reflection mirror 46c is reflected to be incident on the second beam splitter BS2.

The high reflection mirror 141 and the high reflection mirror 142 configure a folded optical path FOP for guiding the pulse laser light having passed through the second loop optical path LOP2 to the first loop optical path LOP1. The high reflection mirrors 141, 142 are examples of the “folded propagation optical system” in the present disclosure, and the folded optical path FOP is an example of the “optical path formed in the optical propagation optical system” in the present disclosure.

Further, in the L-OPS 100C, a beam rotation mechanism 157 configured by a high reflection mirror 153 and a high reflection mirror 154 is arranged instead of the high reflection mirror 143 in FIG. 4.

The second beam splitter BS2 is arranged on the optical path between the high reflection mirror 128 and the high reflection mirror 141. Alternatively, the second beam splitter BS2 may be arranged on the optical path between the high reflection mirror 142 and the high reflection mirror 153.

The mirrors are arranged such that the second loop optical path LOP2 and the propagation optical path of the pulse laser light configured by the high reflection mirror 128, the high reflection mirror 141, the high reflection mirror 142, the high reflection mirror 153, and the high reflection mirror 154 are arranged on the same plane.

The first beam splitter BS1 is arranged on the optical path between the high reflection mirror 154 and the high reflection mirror 46d.

Further, a beam rotation mechanism 47 configured by the high reflection mirror 46d and the high reflection mirror 46e is arranged instead of the high reflection mirror 44c in FIG. 4.

### 6.3.2 Operation

The pulse laser light output from the power oscillator 30 is incident on the high reflection mirror 128 via the high reflection mirrors 46a, 46b, 46c and is reflected by the high reflection mirror 128 to be incident on the second beam splitter BS2.

The longitudinal direction of the beam cross section of the pulse laser light incident on the high reflection mirror 46a is oriented in the V-axis direction. The longitudinal direction of the beam cross section of the pulse laser light reflected by the high reflection mirrors 46a, 46b, 46c and output from the high reflection mirror 46c is oriented in the V-axis direction. That is, the high reflection mirrors 46a to 46c propagate the pulse laser light without rotating the beam (with no rotation).

The beam non-rotationally propagated via the high reflection mirrors 46a, 46b, 46c is oriented such that the longitudinal direction of the beam cross section of the pulse laser light is perpendicular to the second loop optical path plane in the second loop optical path LOP2.

The pulse laser light propagated via the high reflection mirrors 46a, 46b, 46c, and the high reflection mirror 128 is incident on the first surface of the second beam splitter BS2, and the pulse laser light reflected by the first surface of the second beam splitter BS2 propagates through the second loop optical path LOP2. The pulse laser light transmitted through the first surface of the second beam splitter BS2 and the pulse laser light propagated via the second loop optical path LOP2 and reflected by the second surface of the second beam splitter BS2 are reflected by the high reflection mirrors 141, 142 and then enter the beam rotation mechanism 157.

The beam rotation mechanism 157 rotates the beam of the pulse laser light such that the longitudinal direction of the beam cross section of the pulse laser light is perpendicular to the first loop optical path plane in the first loop optical path LOP1.

The pulse laser light output from the high reflection mirror 154 of the beam rotation mechanism 157 is incident on the first beam splitter BS1. The pulse laser light reflected by the first beam splitter BS1 propagates through the first loop optical path LOP1. The pulse laser light (loop light) reflected by the first beam splitter BS1 after circulating in the first loop optical path LOP1 and the pulse laser light (through light) transmitted through the first beam splitter BS1 without circulating in the first loop optical path LOP1 enter the beam rotation mechanism 47.

The pulse laser light incident on the high reflection mirror 46d is reflected by the high reflection mirror 46d and the high reflection mirror 46e. The high reflection mirror 46d and the high reflection mirror 46e rotate the beam so that the longitudinal direction of the beam cross section of the pulse laser light output from the high reflection mirror 46e is oriented in the V-axis direction. The pulse laser light reflected by the high reflection mirror 46e enters the OPS 50.

The second loop optical path LOP2 shown in FIG. 11 is an example of the “first loop optical path” in the present disclosure, and the first loop optical path LOP1 shown in FIG. 11 is an example of the “second loop optical path” in the present disclosure. Further, the second beam splitter BS2 shown in FIG. 11 is an example of the “first beam splitter” in the present disclosure, and the first beam splitter BS1 shown in FIG. 11 is an example of the “second beam splitter” in the present disclosure. Each of the concave mirrors 131 to 134 shown in FIG. 11 is an example of the “first concave mirror” in the present disclosure, and each of the concave mirrors 111 to 116 shown in FIG. 11 is an example of the “second concave mirror” in the present disclosure. The beam rotation mechanism 157 is an example of the “first beam rotation mechanism” in the present disclosure.

### 6.4 Effect

The L-OPS 100C and the laser device 2B including the same according to the third embodiment have effects similar to those of the first embodiment. Further, according to the configuration of the third embodiment, the degree of freedom of appropriate arrangement suitable for the surrounding space is increased.

### 6.5 Modification

Instead of the concave mirrors 111 to 116 configuring the first loop optical path LOP1 shown in FIG. 11, the concave mirrors 111 to 118 configuring the first loop optical path LOP1B described with reference to FIG. 5 may be used.

### 7. Electronic Device Manufacturing Method

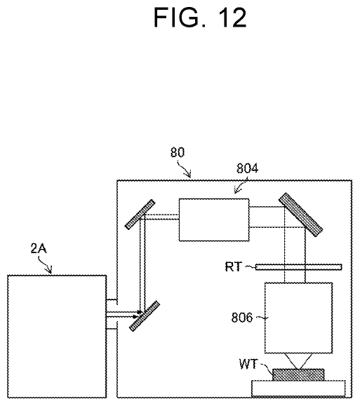

FIG. 12 schematically shows a configuration example of the exposure apparatus 80. The exposure apparatus 80 includes an illumination optical system 804 and a projection optical system 806. The illumination optical system 804 illuminates a reticle pattern of a reticle (not shown) arranged on a reticle stage RT with the laser light incident from the laser device 2A. The projection optical system 806 causes the laser light transmitted through the reticle to be imaged as being reduced and projected on a workpiece (not shown) arranged on a workpiece table WT. The workpiece is a photosensitive substrate such as a semiconductor wafer on which photoresist is applied.

The exposure apparatus 80 synchronously translates the reticle stage RT and the workpiece table WT to expose the workpiece to the laser light reflecting the reticle pattern. After the reticle pattern is transferred onto the semiconductor wafer by the exposure process described above, a semiconductor device can be manufactured through a plurality of processes. The semiconductor device is an example of the “electronic device” in the present disclosure. Not limited to the laser device 2A, the laser device 2B or the like may be used.

### 8. Others

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of any thereof and any other than A, B, and C.

What is claimed is:

1. A pulse width extension device, comprising:
a first delay optical system including a first beam splitter and a plurality of first concave mirrors, and having a first loop optical path formed on a first plane, the first loop optical path being configured by the first beam splitter and the plurality of first concave mirrors;
a second delay optical system including a second beam splitter and a plurality of second concave mirrors, and having a second loop optical path formed on a second plane parallel to and different from the first plane, the second loop optical path being configured by the second beam splitter and the plurality of second concave mirrors; and
a first beam rotation mechanism arranged on an optical path between the first delay optical system and the second delay optical system and configured to rotate a beam of pulse laser light having passed through the first delay optical system so that a longitudinal direction of a beam cross-sectional shape of the pulse laser light traveling on the second loop optical path is perpendicular to the second plane.

2. The pulse width extension device according to claim 1, further comprising a return propagation optical system through which the pulse laser light having passed through the second delay optical system propagates,
wherein an optical path formed in the return propagation optical system is formed on the same plane as the second plane.

3. The pulse width extension device according to claim 2,
wherein the return propagation optical system is configured by a plurality of mirrors.

4. The pulse width extension device according to claim 1,
further comprising a second beam rotation mechanism ahead of the first delay optical system,
wherein the second beam rotation mechanism is configured to rotate a beam of the pulse laser light to enter the first delay optical system so that a longitudinal direction of a beam cross-sectional shape of the pulse laser light traveling on the first loop optical path is perpendicular to the first plane.

5. The pulse width extension device according to claim 4,
wherein the second beam rotation mechanism includes two or more mirrors.

6. The pulse width extension device according to claim 1,
wherein the first delay optical system includes four or more of the first concave mirrors.

7. The pulse width extension device according to claim 1,
wherein the first delay optical system includes an even number of pairs of the first concave mirrors, the first concave mirrors of each pair being arranged to face each other.

8. The pulse width extension device according to claim 1,
wherein the second delay optical system includes four or more of the second concave mirrors.

9. The pulse width extension device according to claim 1,
wherein the second delay optical system includes an even number of pairs of the second concave mirrors, the second concave mirrors of each pair being arranged to face each other.

10. The pulse width extension device according to claim 1,
wherein the first beam rotation mechanism includes two or more mirrors.

11. The pulse width extension device according to claim 1,
wherein the first beam rotation mechanism includes four or more mirrors.

12. The pulse width extension device according to claim 11,
wherein an angle formed between incident light and reflection light of at least one mirror among the four or more mirrors configuring the first beam rotation mechanism is 45 degrees.

13. The pulse width extension device according to claim 1,
wherein the pulse width extension device is arranged on a back side of a laser device which outputs the pulse laser light.

14. The pulse width extension device according to claim 1,
wherein the first surface is parallel to the gravity direction.

15. The pulse width extension device according to claim 1,
wherein the first delay optical system includes 2n pieces of the first concave mirrors and the second delay optical system includes 2m pieces of the second concave mirrors, where each of n and m is an integer of two or more,
the 2n pieces of the first concave mirrors are arranged into rows, each including n pieces of the first concave mirrors, as being faced to each other in a second axis direction, and the n pieces of the first concave mirrors on each of the rows of the first concave mirrors are arranged in a third axis direction, and
the 2m pieces of the second concave mirrors are arranged into rows, each including m pieces of the second concave mirrors, as being faced to each other in the second axis direction, and the m pieces of the second concave mirrors on each of the rows of the second concave mirrors are arranged in the third axis direction,
where a first axis direction represents a direction perpendicular to the first plane, and the second axis direction and the third axis direction represents two directions perpendicular to the first axis direction and perpendicular to each other.

16. The pulse width extension device according to claim 15,
wherein the pulse laser light is incident on the first beam splitter in the first axis direction.

17. The pulse width extension device according to claim 15,
wherein the pulse laser light is incident on the first beam splitter in the third axis direction.

18. The pulse width extension device according to claim 1, further comprising a folded propagation optical system, arranged on an optical path between the first beam splitter and the first beam rotation mechanism, through which the pulse laser light having passed through the first delay optical system propagates,
wherein an optical path formed in the folded propagation optical system is formed on the same plane as the first plane.

19. A laser device comprising:
a laser oscillator configured to output pulse laser light; and
a pulse width extension device arranged on an optical path of the pulse laser light,
the pulse width extension device including:
a first delay optical system including a first beam splitter and a plurality of first concave mirrors, and having a first loop optical path formed on a first plane, the first loop optical path being configured by the first beam splitter and the plurality of first concave mirrors;
a second delay optical system including a second beam splitter and a plurality of second concave mirrors, and having a second loop optical path formed on a second plane parallel to and different from the first plane, the second loop optical path being configured by the second beam splitter and the plurality of second concave mirrors; and
a first beam rotation mechanism arranged on an optical path between the first delay optical system and the second delay optical system and configured to rotate a beam of the pulse laser light having passed through the first delay optical system so that a longitudinal direction of a beam cross-sectional shape of the pulse laser light traveling on the second loop optical path is perpendicular to the second plane.

20. An electronic device manufacturing method, comprising:
generating laser light with a pulse width extended using a laser device;
outputting the laser light to an exposure apparatus; and
exposing a photosensitive substrate to the laser light in the exposure apparatus to manufacture an electronic device,
the laser device including:
a first delay optical system including a first beam splitter and a plurality of first concave mirrors, and having a first loop optical path formed on a first plane, the first loop optical path being configured by the first beam splitter and the plurality of first concave mirrors;
a second delay optical system including a second beam splitter and a plurality of second concave mirrors, and having a second loop optical path formed on a second plane parallel to and different from the first plane, the second loop optical path being configured by the second beam splitter and the plurality of second concave mirrors; and
a first beam rotation mechanism arranged on an optical path between the first delay optical system and the second delay optical system and configured to rotate a beam of the pulse laser light having passed through the first delay optical system so that a longitudinal direction of a beam cross-sectional shape of the pulse laser light traveling on the second loop optical path is perpendicular to the second plane.
